(19) United States
(12) Patent Application Publication
(10) Pub. No.: US 2026/0236390 A1
(43) Pub. Date: Aug. 13, 2026

(54) RELOCATION COMMIT OPERATIONS IN A DATA STORAGE DEVICE FIELD

(71) Applicant: Sandisk Technologies, Inc., Milpitas, CA (US)

(72) Inventors: Govind Kumar Mangal, Bengaluru (IN); Saurabh Singh, Bengaluru (IN)

(21) Appl. No.: 19/049,856

(22) Filed: Feb. 10, 2025

(51) Int. Cl. G06F 12/02

(52) U.S. Cl. CPC G06F 12/0246; G06F 2212/7201

(57) ABSTRACT

A data storage device performs relocation commit operations. In one example, the data storage device includes a controller coupled to the memory device. The controller is configured to receive a relocation commit command, perform a relocation commit operation to move data from a source memory block of the memory device to a destination memory block of the memory device, determine whether the data being relocated is sequential, and determine whether there are any accumulated sequential updates. When the data being relocated is not sequential and there are accumulated sequential updates, the controller will load and update a logical-to-physical (L2P) table in non-volatile memory of the memory device with the accumulated sequential updates and when the data being relocated is not sequential and there are no accumulated sequential updates, the controller will add data entries to an L2P delta in an intermediate memory of the controller.

This application relates generally to data storage devices, and more particularly, to relocation commit operations within a data storage device.

### BACKGROUND

Data storage devices, such as solid-state drives (SSDs) and hard disk drives (HDDs), are widely used in computing systems to store and retrieve digital information. As the capacity and performance requirements of these devices continue to increase, efficient management of data within the storage medium becomes increasingly important.

One important aspect of data management in storage devices is garbage collection, a process that consolidates fragmented data and frees up space for new data to be written. During garbage collection, valid data is typically relocated from one area of the storage medium to another. This relocation process, often referred to as a relocation commit operation, involves updating mapping tables that track the physical location of logical data addresses.

Traditionally, relocation commit operations have been implemented using a combination of volatile memory (e.g., RAM) and non-volatile memory (e.g., NAND flash) to manage mapping information. The process typically involves temporarily storing mapping updates in RAM before eventually committing them to the non-volatile memory. This approach allows for quick access to recent mapping changes but can lead to increased write amplification and resource consumption.

As storage devices continue to evolve with larger capacities and more complex architectures, the efficiency of relocation commit operations becomes increasingly more important. Inefficient commit processes may result in increased latency, reduced performance, and higher power consumption. Additionally, as block sizes in memory devices grow larger, the amount of mapping information that needs to be managed during relocation operations also increases, putting further strain on system resources.

### SUMMARY

The growing demand for faster, more efficient storage systems has led to a need for improved techniques in managing data relocation and mapping updates. The processes of the present application may increase overall system performance, reduce resource utilization, and improve endurance of storage media.

In some aspects, the present disclosure describes a data storage device including a memory device and a controller coupled to the memory device. The controller is configured to receive a relocation commit command, perform a relocation commit operation to move data from a source memory block of the memory device to a destination memory block of the memory device, determine whether there are any accumulated sequential updates equal to or more than a predefined length of accumulated sequential updates. Responsive to determining that there are accumulated sequential updates equal to or more than a predefined length of accumulated sequential updates, the controller is configured to load and update a logical-to-physical (L2P) table in non-volatile memory of the memory device with the accumulated sequential updates. Responsive to determining that there are no accumulated sequential updates equal to or more than a predefined length of accumulated sequential updates, the controller is configured to add data entries to an L2P delta in an intermediate memory of the controller.

In some aspects, the present disclosure describes a method including: receiving, with a controller, a relocation commit command; performing, with the controller, a relocation commit operation to move data from a source memory block of a memory device to a destination memory block of the memory device; determining, with the controller, whether there are any accumulated sequential updates equal to or more than a predefined length of accumulated sequential updates; Responsive to determining that there are accumulated sequential updates equal to or more than a predefined length of accumulated sequential updates, loading and updating, with the controller, a logical-to-physical (L2P) table in non-volatile memory of the memory device with the accumulated sequential updates; and responsive to determining that there are no accumulated sequential updates equal to or more than a predefined length of accumulated sequential updates, adding, with the controller, data entries to an L2P delta in an intermediate memory of the controller.

In some aspects, the present disclosure also describes a non-transitory computer-readable medium including instructions that, when executed by an electronic processor, cause the electronic processor to perform a set of operations including: receiving a relocation commit command; performing a relocation commit operation to move data from a source memory block of a memory block to a destination memory block of the memory block; determining whether there are any accumulated sequential updates equal to or more than a predefined length of accumulated sequential updates; responsive to determining that there are accumulated sequential updates equal to or more than the predefined length of accumulated sequential updates, loading and updating a logical-to-physical (L2P) table in non-volatile memory of the memory device with the accumulated sequential updates; and responsive to determining that there are no accumulated sequential updates equal to or more than the predefined length of accumulated sequential updates, adding data entries to an L2P delta in an intermediate memory of the controller.

Various aspects of the present disclosure provide for improvements in data storage devices. The present disclosure can be embodied in various forms, including hardware or circuits controlled by software, firmware, or a combination thereof. The foregoing summary is intended solely to give a general idea of various aspects of the present disclosure and does not limit the scope of the present disclosure in any way.

### BRIEF DESCRIPTION OF THE DRAWINGS

FIG. 1 is block diagram illustrating one example of a system including a data storage device, according to some embodiments.

FIG. 2 is a flowchart illustrating a first example method of a relocation commit operations in a data storage device, according to some embodiments.

FIGS. 3A and 3B are diagrams illustrating general relocation commit operations with respect to the first example method, according to some embodiments.

FIG. 4 is a flow chart illustrating a second example method of a relocation commit operation process, according to some embodiments.

FIG. 5 is a diagram illustrating a relocation commit operation with respect to the second example method, according to some embodiments.

### DETAILED DESCRIPTION

In the following description, numerous details are set forth, such as data storage device configurations, controller operations, and the like, in order to provide an understanding of one or more aspects of the present disclosure. It will be readily apparent to one skilled in the art that these specific details are merely exemplary and not intended to limit the scope of this application. In particular, the functions associated with the controller can be performed by hardware (for example, analog or digital circuits), a combination of hardware and software (for example, program code or firmware stored in a non-transitory computer-readable medium that is executed by a processor or control circuitry), or any other suitable means. The following description is intended solely to give a general idea of various aspects of the present disclosure and does not limit the scope of the disclosure in any way. Furthermore, it will be apparent to those of skill in the art that, although the present disclosure refers to NAND flash, the concepts discussed herein are applicable to other types of solid-state memory, such as NOR, PCM (“Phase Change Memory”), ReRAM, MRAM, etc.

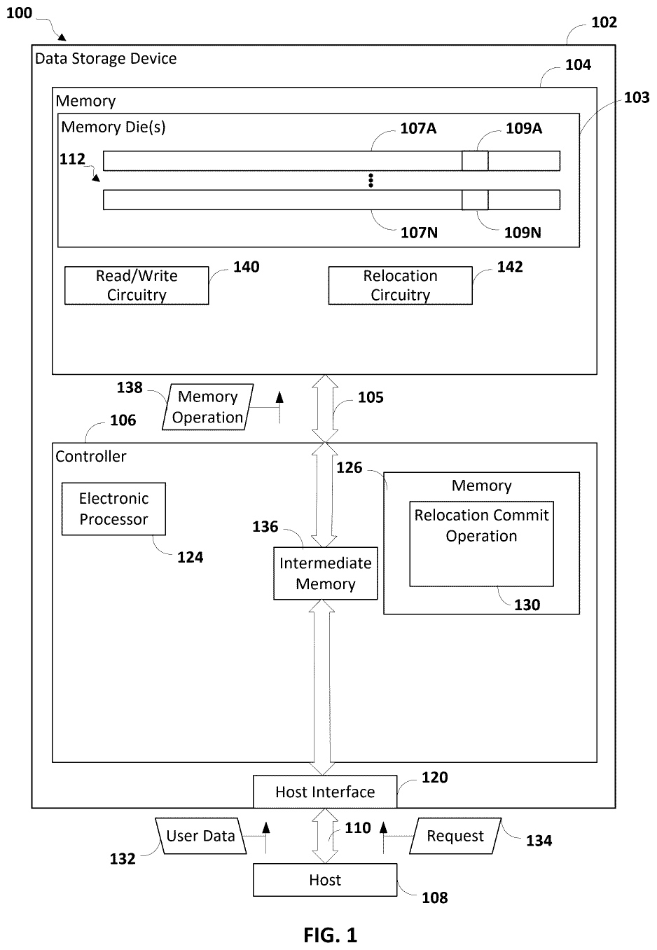

FIG. 1 is block diagram illustrating one example of a system 100 including a data storage device 102, according to some embodiments. In the example of FIG. 1, the system 100 includes a data storage device 102 in communication with a host device 108. The data storage device 102 includes a memory device 104 (e.g. non-volatile memory) that is coupled to a controller 106.

One example of the structural and functional features provided by the controller 106 are illustrated in FIG. 1. However, the controller 106 is not limited to the structural and functional features provided by the controller 106 in FIG. 1. The controller 106 may include fewer or additional structural and functional features that are not illustrated in FIG. 1.

The data storage device 102 and the host device 108 may be operationally coupled via a connection (e.g., a communication path 110), such as a bus or a wireless connection. In some examples, the data storage device 102 may be embedded within the host device 108. Alternatively, in other examples, the data storage device 102 may be removable from the host device 108 (i.e., “removably” coupled to the host device 108). As an example, the data storage device 102 may be removably coupled to the host device 108 in accordance with a removable universal serial bus (USB) configuration. In some implementations, the data storage device 102 may include or correspond to a solid state drive (SSD), which may be used as an embedded storage drive (e.g., a mobile embedded storage drive) , an enterprise storage drive (ESD), a client storage device, or a cloud storage drive, or other suitable storage drives.

The data storage device 102 may be configured to be coupled to the host device 108 via the communication path 110, such as a wired communication path and/or a wireless communication path. For example, the data storage device 102 may include an interface 120 (e.g., a host interface) that enables communication via the communication path 110 between the data storage device 102 and the host device 108, such as when the interface 120 is communicatively coupled to the host device 108.

The host device 108 may include a processor and a memory. The memory may be configured to store data and/or instructions that may be executable by the processor. The memory may be a single memory or may include one or more memories, such as one or more non-volatile memories, one or more volatile memories, or a combination thereof. The host device 108 may issue one or more commands to the data storage device 102, such as one or more requests to erase data at, read data from, or write data to the memory device 104 of the data storage device 102. For example, the host device 108 may be configured to provide data, such as user data 132, to be stored at the memory device 104 or to request data to be read from the memory device 104. The host device 108 may include a mobile smartphone, a music player, a video player, a gaming console, an electronic book reader, a personal digital assistant (PDA), a computer, such as a laptop computer or notebook computer, any combination thereof, or other suitable electronic device.

The host device 108 communicates via a memory interface that enables reading from the memory device 104 and writing to the memory device 104. In some examples, the host device 108 may operate in compliance with an industry specification, such as a Universal Flash Storage (UFS) Host Controller Interface specification. In other examples, the host device 108 may operate in compliance with one or more other specifications, such as a Secure Digital (SD) Host Controller specification or other suitable industry specification. The host device 108 may also communicate with the memory device 104 in accordance with any other suitable communication protocol.

The memory device 104 of the data storage device 102 may include a non-volatile memory (e.g., NAND, BiCS family of memories, or other suitable memory). In some examples, the memory device 104 may be any type of flash memory. For example, the memory device 104 may be two-dimensional (2D) memory or three-dimensional (3D) flash memory. The memory device 104 may include one or more memory dies 103. Each of the one or more memory dies 103 may include one or more memory blocks 112 (e.g., one or more erase blocks). Each memory block 112 may include one or more groups of storage elements, such as a representative group of storage elements 107A-107N. The group of storage elements 107A-107N may be configured as a wordline. The group of storage elements 107A-107N may include multiple storage elements (e.g., memory cells that are referred to herein as a “string”), such as a representative storage elements 109A and 109N, respectively. In some examples, the storage elements 107A-107N may be referred to as a flash management unit (“FMU”). In other examples, an FMU may be equivalent to one or both of storage elements 109A and 109N. In yet other examples, an FMU is equivalent to the memory block 112 and may therefore be used interchangeably with the term “memory block.”

The memory device 104 may include support circuitry, such as read/write circuitry 140 and relocation circuitry 142. Although depicted as a single component, the read/write circuitry 140 may be divided into separate components of the memory device 104, such as read circuitry and write circuitry. The read/write circuitry 140 may be external to the one or more memory dies 103 of the memory device 104. Alternatively, one or more individual memory dies 103 may include corresponding read/write circuitry 140 that is operable to read from and/or write to storage elements within the individual memory die independent of any other read and/or write operations at any of the other memory dies.

The controller 106 is coupled to the memory device 104 (e.g., the one or more memory dies 103) via a bus 105, an interface (e.g., interface circuitry), another structure, or a combination thereof. For example, the bus 105 may include multiple distinct channels to enable the controller 106 to communicate with each of the one or more memory dies 103 in parallel with, and independently of, communication with the other memory dies 103.

The controller 106 is configured to receive data and instructions from the host device 108 and to send data to the host device 108. For example, the controller 106 may send data to the host device 108 via the interface 120, and the controller 106 may receive data from the host device 108 via the interface 120. The controller 106 is configured to send data and commands (e.g., the memory operation 138, which may be a cycle operation of a memory block of the memory device 104) to the memory device 104 and to receive data from the memory device 104. For example, the controller 106 is configured to send data and a program or write command to cause the memory device 104 to store data to a specified address of the memory device 104. The write command may specify a physical address of a portion of the memory device 104 (e.g., a physical address of a word line of the memory device 104) that is to store the data.

The controller 106 is configured to send a read command to the memory device 104 to access data from a specified address of the memory device 104. The read command may specify the physical address of a region of the memory device 104 (e.g., a physical address of a word line of the memory device 104). The controller 106 may also be configured to send data and commands to the memory device 104 associated with background scanning operations, garbage collection operations, and/or wear-leveling operations, or other suitable memory operations.

The controller 106 may include a processor 124, a memory 126, and other associated circuitry. The memory 126 may be configured to store data and/or instructions that may be executable by the processor 124. The memory 126 may include a relocation commit operation application 130. The controller 106 may further include an intermediate memory 136, such as a Random Access Memory (“RAM”). However, other memory types may also be used. The intermediate memory 136 memory may be used to temporarily store data from the host 108 prior to storage in the memory 104, and vice versa. While shown in the controller 106, in other applications the intermediate memory may be located in the host interface 120, the memory 104, or other suitable location.

The relocation commit operation application 130 may be configured to perform one or more relocation commit operations as described in more detail below. The relocation commit operations may be used to increase the rate of data transfer from a host device, such as host 108, to a data storage device, such as data storage device 102.

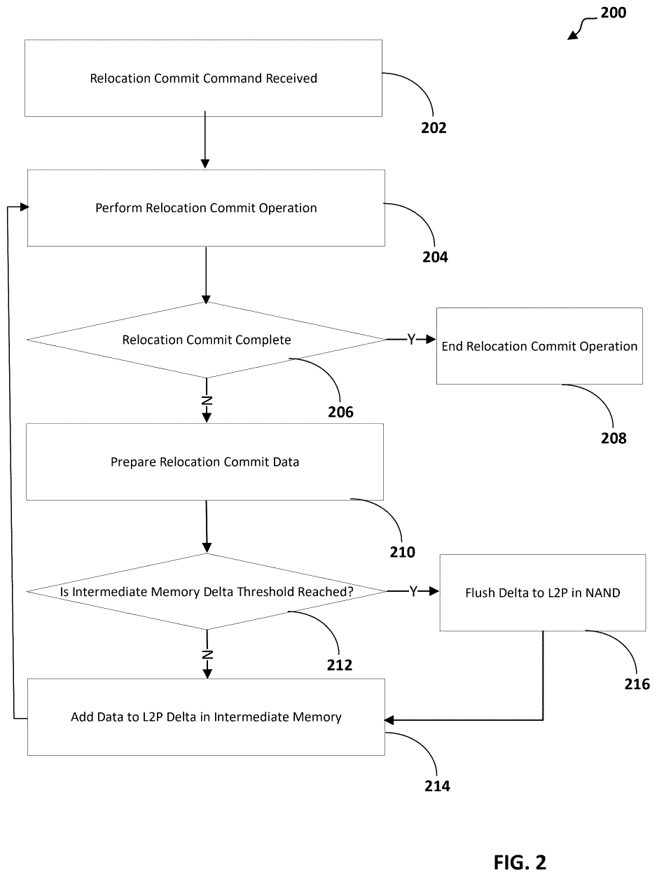

FIG. 2 is a flowchart illustrating a first example method 200 of a relocation commit operations in a data storage device, according to some embodiments. The method 200 may be performed by a controller, such as the controller 106 of FIG. 1.

The method 200 includes receiving a relocation commit command (at block 202). This command may be generated internally by the controller.

The method 200 initiating a relocation commit operation (at block 204). This operation involves moving data from a source location to a destination location within the memory device (e.g., memory 104 of FIG. 1).

The method 200 includes determining whether the relocation commit operation is complete (at decision block 206). When the operation is complete (“YES” at decision block 206), the method 200 includes the controller ending the relocation commit operation (at block 208).

When the operation is not complete (“NO” at decision block 206), the method 200 includes the controller prepares relocation commit data (at block 210). The preparation of relation commit data may involve identifying the data to be relocated and determining the destination location for the data.

The method 200 includes checking whether a delta threshold of an intermediate memory (e.g., the intermediate memory 136 of FIG. 1) has been reached (at decision block 212). This delta threshold may represent a certain amount of mapping information stored in the intermediate memory.

When the threshold has been reached (“YES” at decision block 212), the method 200 includes the controller flushing the delta information to the L2P (Logical to Physical) table in NAND memory (at block 216). The flushing of the delta information updates the persistent mapping information stored in non-volatile memory. After flushing the delta information to the L2P (Logical to Physical) table in NAND memory, the method 200 includes the controller adding data to the L2P delta in the intermediate memory (at block 214). The addition of data to the L2P delta involves updating the temporary mapping information stored in volatile memory.

When the threshold has not been reached (“No” at decision block 212), the method 200 includes the controller adding data to the L2P delta in the intermediate memory (at block 214). The addition of data to the L2P delta involves updating the temporary mapping information stored in volatile memory.

The method 200 also includes the controller looping back to performing the relocation commit operation (at block 204).

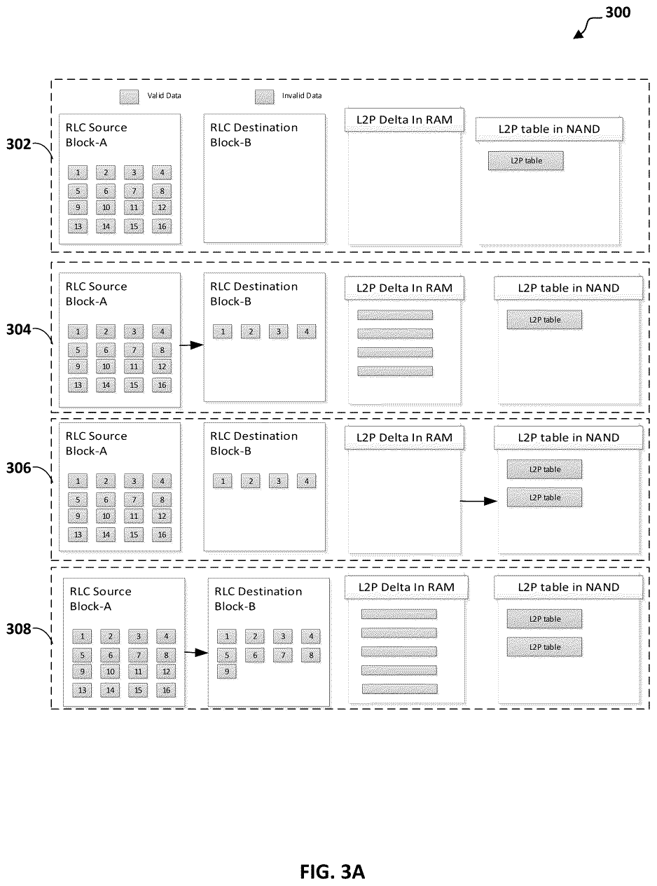

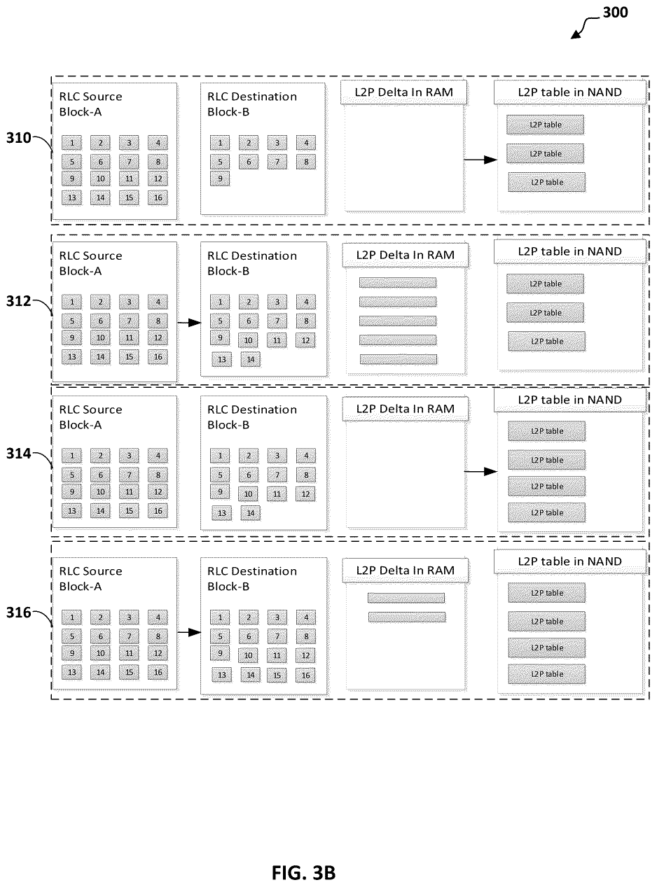

FIGS. 3A and 3B are diagrams illustrating general relocation commit operations 302-316 (collectively “general relocation commit operations 300”) with respect to the first example method 200, according to some embodiments. The general relocation commit operations 300 includes a first general relocation commit operation 302 through an eighth general relocation commit operation 316. Each of the first general relocation commit operation 302 through the eighth general relocation commit operation 316 further includes a source block, a destination block, a RAM delta table, and a NAND table.

The first general relocation commit operation 302 includes the source block containing a first amount of valid data, the destination block is empty, the RAM delta table is empty, and the NAND includes an L2P table.

The second general relocation commit operation 304 includes the source block moving some of the first amount of valid data to the destination block. As a first portion of the valid data is relocated, entries are created in the RAM L2P delta table that correspond to the first portion of the valid data, as shown by RAM delta entries.

The third general relocation commit operation 306 includes the RAM L2P delta table moving the RAM delta entries to the L2P table in the NAND, which updates the existing L2P table or creates a second updated L2P table in the NAND from the existing L2P table.

The fourth general relocation commit operation 308 includes the source block containing a second amount of valid data, the destination block includes the first portion of the valid data and a second portion of the valid data, entries are created in the RAM L2P delta table that correspond to the second portion of the valid data, as shown by the RAM delta entries, and the NAND includes the second updated L2P table (or the existing updated L2P table).

The fifth general relocation commit operation 310 includes the RAM L2P delta table moving the RAM delta entries to the L2P table in the NAND, which updates the existing L2P table or creates a third updated L2P table in the NAND from the second updated L2P table.

The sixth general relocation commit operation 312 includes the source block moving some of the second amount of valid data to the destination block. As a third portion of the valid data is relocated, entries are created in the RAM L2P delta table that correspond to the third portion of the valid data, as shown by RAM delta entries.

The seventh general relocation commit operation 314 includes the RAM L2P delta table moving the RAM delta entries to the L2P table in the NAND, which updates the existing L2P table or creates a fourth updated L2P table in the NAND.

The eighth general relocation commit operation 316 includes the source block moving the remaining portion of the valid data to the destination block such that the destination block includes all of the valid data, entries are created in the RAM L2P delta table that correspond to the remaining portion of the valid data, as shown by the RAM delta entries, and the NAND includes the third updated L2P table (or the existing updated L2P table).

Although not shown, a ninth general relocation commit operation may also include the RAM L2P delta table moving the RAM delta entries to the L2P table in the NAND, which updates the existing L2P table or creates a fifth updated L2P table in the NAND.

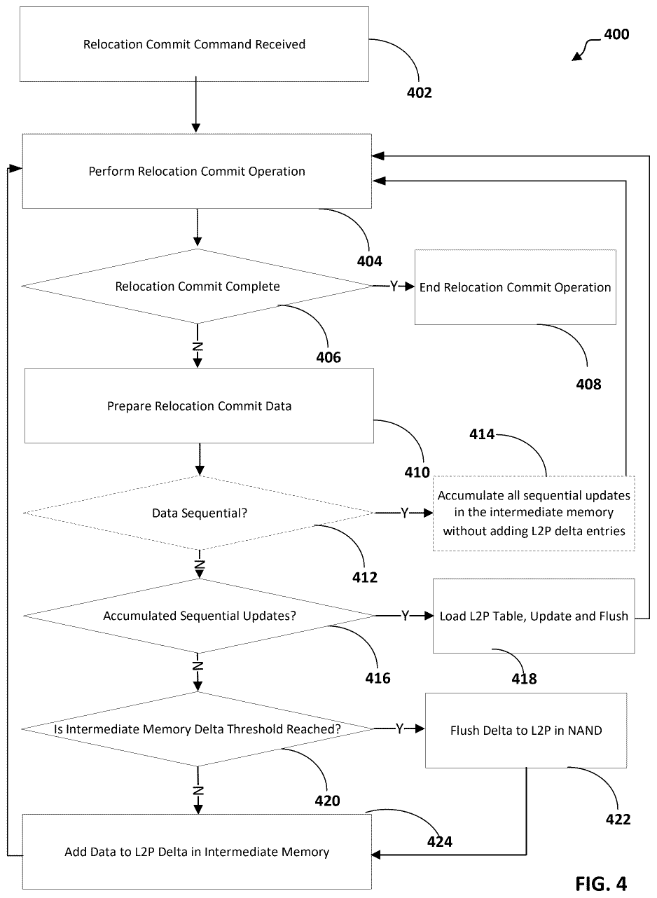

FIG. 4 is a flowchart illustrating a second example method 400 of a relocation commit operations in a data storage device, according to some embodiments. The method 400 may be performed by a controller, such as the controller 106 of FIG. 1.

The method 400 includes receiving a relocation commit command (at block 402). The method 400 includes the controller performing a relocation commit operation (at block 404).

The method 400 includes the controller checking whether the full block commit is done (at decision block 406). When the full block commit is done (“YES” at decision block 406), the method 400 includes the controller ending the relocation commit operation (at block 408).

In some examples, when the full block commit is not done (“NO” at decision block 406), the method 400 may optionally include the controller determining whether the data being relocated is sequential (at optional decision block 412).

In these examples, when the controller determines that the data is sequential to previous commit data (“YES” at optional decision block 412), the method 400 includes the controller accumulating all sequential updates in the intermediate memory without adding L2P delta entries (at optional block 414) and reverts to performing the relocation commit operation (at block 404).

In these examples, when the controller determines that the data is not sequential to previous commit data (“NO” at optional decision block 412) or, in other examples, when the full block commit is not done (“NO” at decision block 406), the method 400 includes the controller determining whether there are accumulated sequential updates in the intermediate memory equal to or more than a predefined length of accumulated sequential updates (at decision block 416).

When the controller determines there are accumulated sequential updates in the intermediate memory equal to or more than he predefined length of accumulated sequential updates, (“YES” at decision block 416), the method 400 includes the controller loading and updating the L2P table in the NAND and flushing the accumulated sequential updates from the intermediate memory (at block 418) and then reverting to performing the relocation commit operation (at block 404).

When the controller determines there are no accumulated sequential updates in the intermediate memory equal to or more than the predefined length of accumulated sequential updates, (“NO” at decision block 416), the method 400 includes the controller checking whether an intermediate memory delta threshold is reached (at decision block 420).

When the controller determines that the intermediate memory delta threshold is reached (“YES” at decision block 420), the method 400 includes the controller moving the delta to the L2P table in the NAND and flushing the delta from the intermediate memory (at block 422).

When the controller determines that the intermediate memory delta threshold is not reached (“NO” at decision block 420), the method 400 includes the controller adding data to the L2P delta in the intermediate memory (at block 424).

After adding data to the L2P delta in the intermediate memory, the method 400 also includes looping back to perform the relocation commit operation on any additional data (at block 404). When the relocation commit operation is completed, the controller ends the relocation commit operation (at block 408).

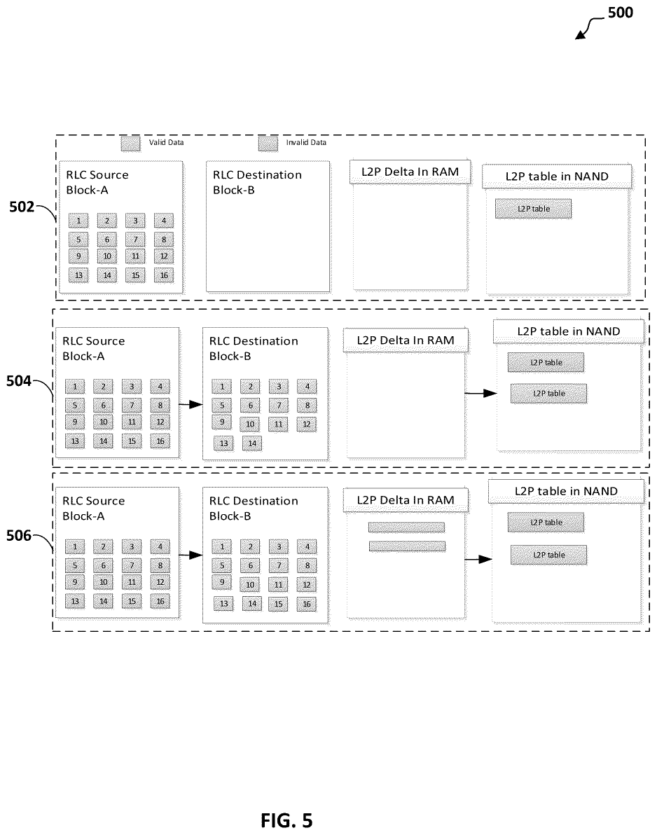

FIG. 5 is a diagram illustrating relocation commit operations 502-506 (collectively “relocation commit operations 500”) with respect to the second example method 400, according to some embodiments. The relocation commit operations 500 includes a first relocation commit operation 502 through a third relocation commit operation 506. Each of the first relocation commit operation 502 through the third relocation commit operation 506 further includes a source block, a destination block, a RAM delta table, and a NAND table.

In the first relocation commit operation 502, the source data block contains valid data to be relocated, the destination data block is empty, the intermediate mapping table in RAM is empty, and the NAND mapping table contains the initial mapping information (e.g., an initial L2P table).

In the second relocation commit operation 504, the sequential data (i.e., blocks 1-14) may move directly from the source data block to the destination data block, potentially bypassing the RAM mapping table. The updated NAND table may reflect these changes (i.e., the move of blocks 1-14 from the source data block to the destination data block) directly.

In the third relocation commit operation 506, non-sequential data entries may be created in the intermediate mapping table within the RAM mapping table. The process may conclude with the final mapping table in NAND being updated to reflect all changes, both sequential and non-sequential.

The use of relocation commit operations 502-506 reduces the number of entries in the RAM mapping table and minimizes the number of updates to the NAND mapping table, which may increase the efficiency of the relocation commit operation.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain implementations and should in no way be construed to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A data storage device comprising:
a memory device; and
a controller coupled to the memory device, the controller being configured to:
receive a relocation commit command;
perform a relocation commit operation to move data from a source memory block of the memory device to a destination memory block of the memory device;
determine whether there are any accumulated sequential updates equal to or more than a predefined length of accumulated sequential updates;
responsive to determining that there are accumulated sequential updates equal to or more than the predefined length of accumulated sequential updates, load and update a logical-to-physical (L2P) table in non-volatile memory of the memory device with the accumulated sequential updates; and
responsive to determining that there are no accumulated sequential updates equal to or more than the predefined length of accumulated sequential updates, add data entries to an L2P delta in an intermediate memory of the controller.

2. The data storage device of claim 1, wherein the controller is further configured to:
flush the L2P delta to the L2P table in the non-volatile memory after loading and updating the L2P table in the non-volatile memory of the memory device with the accumulated sequential updates.

3. The data storage device of claim 1, wherein the controller is further configured to:
responsive to determining that there are no accumulated sequential updates, check whether an intermediate memory delta threshold of the intermediate memory is reached; and
when the intermediate memory delta threshold is reached, flush the L2P delta to the L2P table in the non-volatile memory.

4. The data storage device of claim 3, wherein the controller is further configured to:
when the L2P delta has been flushed, add new data to a new L2P delta in the intermediate memory.

5. The data storage device of claim 1, wherein the controller is further configured to:
determine whether additional data needs to be committed after updating the L2P table or adding data to the L2P delta; and
perform the relocation commit operation on the additional data.

6. The data storage device of claim 1, wherein the intermediate memory includes a random access memory (RAM).

7. The data storage device of claim 1, wherein the non-volatile memory includes a NAND memory.

8. The data storage device of claim 1, wherein the controller is further configured to:
determine whether the data being relocated is sequential, and
responsive to determining that the data being relocated is sequential, accumulate all sequential updates.

9. The data storage device of claim 8, wherein, to perform the relocation commit operation to move the data from the source memory block to the destination memory block, the controller is further configured to:
bypass the intermediate memory when the data being relocated is sequential.

10. The data storage device of claim 8, wherein the controller is further configured to:
responsive to determining that the data being relocated is not sequential, create entries in a data table within the intermediate memory that correspond to the data that is not sequential.

11. A method comprising:
receiving, with a controller, a relocation commit command;
performing, with the controller, a relocation commit operation to move data from a source memory block of a memory device to a destination memory block of the memory device;
determining, with the controller, whether there are any accumulated sequential updates equal to or more than a predefined length of accumulated sequential updates;
responsive to determining that there are accumulated sequential updates equal to or more than the predefined length of accumulated sequential updates, loading and updating, with the controller, a logical-to-physical (L2P) table in non-volatile memory of the memory device with the accumulated sequential updates; and
responsive to determining that there are no accumulated sequential updates equal to or more than the predefined length of accumulated sequential updates, adding, with the controller, data entries to an L2P delta in an intermediate memory of the controller.

12. The method of claim 11, further comprising:
flushing the L2P delta to the L2P table in the non-volatile memory after loading and updating the L2P table in the non-volatile memory of the memory device with the accumulated sequential updates.

13. The method of claim 11, further comprising:
responsive to determining that there are no accumulated sequential updates, checking whether an intermediate memory delta threshold of the intermediate memory is reached; and
when the intermediate memory delta threshold is reached, flushing the L2P delta to the L2P table in the non-volatile memory.

14. The method of claim 13, further comprising:
when the L2P delta has been flushed, adding new data entries to a new L2P delta in the intermediate memory.

15. The method of claim 11, further comprising:
determining whether additional data needs to be committed after updating the L2P table or adding data to the L2P delta; and
performing the relocation commit operation on the additional data.

16. The method of claim 11, further comprising:
determining whether the data being relocated is sequential, and
responsive to determining that the data being relocated is sequential, accumulate all sequential updates.

17. The method of claim 16, wherein performing the relocation commit operation to move the data from the source memory block to the destination memory block further includes bypassing the intermediate memory in response to determining that the data being relocated is sequential.

18. The method of claim 16, further comprising:
responsive to determining that the data being relocated is not sequential, creating data entries in a data table within the intermediate memory that correspond to the data being relocated that is not sequential.

19. A non-transitory computer-readable medium comprising instructions that, when executed by an electronic processor, cause the electronic processor to perform a set of operations comprising:
receiving a relocation commit command;
performing a relocation commit operation to move data from a source memory block of a memory device to a destination memory block of the memory device;
determining whether there are any accumulated sequential updates equal to or more than a predefined length of accumulated sequential updates;
responsive to determining that there are accumulated sequential updates equal to or more than the predefined length of accumulated sequential updates, loading and updating a logical-to-physical (L2P) table in non-volatile memory of the memory device with the accumulated sequential updates; and
responsive to determining that there are no accumulated sequential updates equal to or more than the predefined length of accumulated sequential updates, adding data entries to an L2P delta in an intermediate memory of the controller.

20. The non-transitory computer-readable medium of claim 19,
wherein the set of operations further includes determining whether the data being located is sequential,
wherein performing the relocation commit operation to move the data from the source memory block to the destination memory block further includes bypassing the intermediate memory in response to determining that the data being relocated is sequential.
